(19) United States
(12) Patent Application Publication
(10) Pub. No.: US 2025/0248880 A1
(43) Pub. Date: Aug. 7, 2025

(54) LIFTING APPARATUS FOR ASSISTING A USER TO STAND AND AN EXERCISE SYSTEM FOR TRAINING A USER

(71) Applicant: Logistics and Supply Chain MultiTech R&D Centre Limited, Pok Fu Lam (HK)

(72) Inventors: Hong Man WONG, Pok Fu Lam (HK); King Sau WONG, Pok Fu Lam (HK); Ka Lun FAN, Pok Fu Lam (HK)

(21) Appl. No.: 18/435,079

(22) Filed: Feb. 7, 2024

(51) Int. Cl. A61H 3/04

(52) U.S. Cl. CPC A61H 3/04; A61H 2003/043; A61H 2201/01; A61H 2201/1207; A61H 2201/1284; A61H 2201/5007; A61H 2201/5023; A61H 2201/5084; A61H 2201/5092

(57) ABSTRACT

A lifting apparatus for assisting a user to stand including a chassis, a support structure extending upward from the chassis, a lift mechanism disposed on the support structure, a lifting unit adapted to couple to the lift mechanism and bear the weight of a user, wherein the lifting unit is moveable in three axes and moveable from a first position to a second position, and; wherein the lift mechanism is configured to move the lifting unit, and the lifting unit is configured to assist a user to a standing position from a seated position as the lifting unit is moved from a first position to a second position.

### TECHNICAL FIELD

The present invention relates to a lifting apparatus for assisting a user to stand from a seated position. The present invention also relates to an exercise system for training a user, in particular, for training the sit to stand motion of a user. The present invention further relates to a method for training a sit to stand movement.

### BACKGROUND

Many persons require assistance to stand from a seated position. Generally, these persons have a reduced physical capacity due to age, illness or physical disability. Reduced lower body musculature strength e.g., reduced lower limb strength can increase risk of falling. This is particularly, prevalent in elderly persons. Elderly persons often can lose between 1%-3% of their lower limb strength. This loss of strength can often increase the risk of falling, which can lead to serious injury. Additionally, the continued loss of strength may eventually cause a user to become bed ridden.

Research indicates a supervised, progressive resistance training is safe and effective in improving strength. However, it can be challenging for elderly users to exercise and specifically train the sit to stand motion. Performing multiple repetitions of sit to stand movements can lead to lower limb muscle fatigue. Persons with existing joint pain may experience increased joint discomfort during sit to stand training. Elderly persons with balance problems may find it challenging to perform sit to stand exercises without support or assistance. There are some existing devices to assist a user to stand from a seated position. However, many of these devices are often limited to a single axis of movement, are quite large and bulky and often limited to a single function.

### SUMMARY OF THE INVENTION

The present invention relates to a lifting apparatus for assisting a user (e.g., a person) with a sit to stand motion. In particular, the present invention relates to a lifting apparatus for assisting a seated person to a standing position. The lifting apparatus is particularly suited for use by elderly users to assist these elderly users to stand from a seated position.

The exercise system comprises the lifting apparatus and one or more other components that may be used to deliver an exercise program to a user. The exercise system is used to train a user to stand from a seated position to strengthen the appropriate muscles to improve the user's ability to stand from a seated position. The exercise program utilises the lifting apparatus as an exercise tool to help a user strengthen their muscles and improve balance. The lifting apparatus can assist resistance training of elderly users and improve mobility for elderly users.

In accordance with a first aspect, the present invention relates to a lifting apparatus for assisting a user to stand comprising:
a chassis,
a support structure extending upward from the chassis,
a lift mechanism disposed on the support structure,
a lifting unit adapted to couple to the lift mechanism and bear the weight of a user,
wherein the lifting unit is moveable in three axes and moveable from a first position to a second position, and;
wherein the lift mechanism is configured to move the lifting unit, and the lifting unit is configured to assist a user to a standing position from a seated position as the lifting unit is moved from a first position to a second position.

The lifting apparatus allows for customised movement in three axes. The apparatus provides a tool to allow a user to exercise. The lifting apparatus is also advantageous as it assists a user to stand from a seated position.

In one example the lift mechanism comprises: three actuators, wherein each actuator is configured to move the lift mechanism in one axis, and; wherein the lift mechanism is adapted to move the lifting unit in three axes and move the lifting unit from the first position to the second position.

In one example the lifting apparatus may further comprise a controller operatively coupled to each actuator and configured to control each actuator independently to move the lifting unit from the first position to the second position.

The lifting apparatus may further comprise a wireless communication module. The lifting apparatus is adapted to wirelessly communicate with an exercise server or a user device or another device.

In one example the controller is configured to:
receive or store a predefined lifting trajectory to move a user along a customised path from a seated position to a standing position, and;
control the lift mechanism to move the lifting unit along the predefined lifting trajectory.

In one example the predefined lifting trajectory may be a custom lifting trajectory for a specific user. The custom lifting trajectory may be changed or updated at regular intervals. The custom lifting trajectory may be defined as part of a custom exercise program for a user.

In one example the controller is configured to control each of the three actuators independently to move the lift mechanism and thereby move the lifting unit along the predefined lifting trajectory.

In one example each actuator may be a linear actuator, wherein each linear actuator may comprise a DC motor and an encoder adapted to determine a position of the motor and provide the position information to the controller.

In one example the lift mechanism comprises:
a column extending upwardly,
a trolley moveably mounted to the support structure and the column coupled to the trolley,
the column and trolley being moveable vertically relative to the support structure,
a moveable platform coupled to the column, the platform pivotable about vertical axis of the column and the platform or a portion of the platform being horizontally moveable,
wherein at least one actuator operatively connected to the trolley and adapted to actuate vertical movement of the trolley,
wherein at least one actuator operatively connected to the platform and adapted to facilitate pivoting of the platform, and;
wherein at least one actuator operatively connected to the platform or a portion of the platform and adapted to facilitate horizontal movement of the platform,
wherein the lifting unit comprises a central body and one or more outwardly extending arms to engage with a user, the lifting unit is removably coupled to the lifting mechanism.

In one example the lifting unit comprises a pair of arms extending from a central beam, the arms extending outwardly from the central beam and parallel to each other, and wherein the central beam is removably coupled to the platform.

In one example apparatus is a modular arrangement including one or more removable components, wherein the lifting apparatus is adapted to be arranged in a transport configuration or a lifting configuration, and wherein the apparatus is operable in the transport configuration to transport a user or the lifting configuration to lift a user from a sitting position to a standing position.

In one example the lifting apparatus may comprise a transport unit adapted to be removably attached to the lift mechanism, and wherein in the transport configuration the transport unit is attached to the lift mechanism and in the lifting configuration the lifting unit is attached to the lift mechanism.

In one example the transport unit comprises a cradle, wherein the cradle and a seat disposed within the cradle, wherein the seat is adapted to support the user when in a seated position.

In one example, the lifting apparatus comprises:
at least two lateral stabilising arms,
each stabilising arm coupled to the chassis and extending laterally from the chassis, and; each lateral stabilising arm is retractable and adapted to move between a retracted position and an operative position.

In the operative position, each stabilising arm is folded down and provides lateral stability. In one example each stabilising arm may comprise a lateral section and an elongate section connected by an elbow.

In one example, the lifting apparatus may comprise one or more rear support legs, each of the one or more rear support legs coupled to the chassis and extending rearwardly from the chassis.

In one example the lifting apparatus comprises a drive assembly adapted to propel the lifting apparatus, wherein the drive assembly comprising at least two wheels attached to opposing sides of the chassis and a hub motor operatively coupled to wheels and adapted to drive the wheels, and; the drive assembly further comprising one or more steering wheel adapted to assist with steering.

In one example, each rear support leg may further comprise a steering wheel. In one example each lateral stabilising arm may also comprise a steering wheel.

In one example, the lifting apparatus may comprise two or more steering wheels adapted to assist steering and coupled to the chassis. In one example each of the steering wheels may be identical to each other. In another example, the steering wheels on the lateral stabilising arms and the steering wheels on the rear support leg may each be smaller than the steering wheels coupled to the chassis. In one example, each steering wheel may be castor wheel or other freely rotatable wheel.

In accordance with a second aspect, the present invention relates to an exercise system for training a user comprising:
a lifting apparatus according to any one or more of the earlier statements,
an exercise server adapted to communicate with the lifting apparatus,
one or more sensors configured to sense a sit to stand movement performed by a user using the lifting apparatus,
wherein the exercise server configured to:
   receive the sensed movement of the user,
   analyse the sensed sit to stand movement,
   determine one or more parameters related to the recorded sit to stand movement,
   store the one or more parameters,
   present the one or more parameters on a user device.

The lifting apparatus may comprise a display. Alternatively, the exercise server may comprise a display e.g., a screen. The one or more parameters may be presented on the lifting apparatus display or on the exercise server display in addition to the user device or as an alternative to being presented on the user device.

In one example the exercise server is configured to: receive a customized sit to stand exercise program, and; present the customised sit to stand exercise program on a display of the lifting apparatus or on a user device.

The customised exercise program may be presented as a reminder on the user device to communicate to the user e.g., an elderly person to perform the specified exercises. The customised exercise program may be presented at regular time intervals until a user completes the program.

In one example the one or more parameters comprise: number of sit to stand repetitions, number of sets, duration to complete the customised program. The one or more parameters may define a score. The score may be a quality score or a quantity score. A quality score may denote how well a user has performed a sit to stand movement. The quality score may also relate to how well a user has followed the custom sit to stand trajectory. The quantity score may relate to the number or reps and sets.

In one example the exercise server comprising:
a training data analysis module configured to:
   analyse the sensed sit to stand movement recorded by the one or more sensors,
   determine the one or more parameters,
a training operation module configured to:
   receive the one or more parameters,
   determine if a user has completed the customised exercise program,
a training record database configured to store the one or more parameters and number of times a user completes the customised exercise program.

An exercise system for training a user of claim 18 wherein the one or more sensors comprise at least a worn sensor and a camera to record the sit to stand movement using the lifting apparatus.

For example, the worn sensor may be an accelerometer or a gyroscope or a IMU including an accelerometer and a gyroscope.

In one example, the server may be configured to receive a video of the user performing the sit to stand movements defined in the exercise program. The exercise server may be configured to perform an object recognition process on the video stream to identify the user and assess the quality and number of reps of the sit to stand movement based on the object recognition process.

In one example the exercise server is configured to:
receive sensor readings from the one or more sensors as the user performs the sit to stand movement,
performing a sit to stand motion analysis based on the sensor readings,
determine a quality of each sit to stand repetition based comparing the recorded movement to a reference sit to stand movement.

In one example the exercise server comprising:
a sit to stand trajectory setting module adapted to determine a customised sit to stand trajectory for a user, wherein the customised sit to stand trajectory is define in the customised exercise program, and; wherein the lifting apparatus is controlled to move the lifting unit in the customised sit to stand trajectory.

In a third aspect, the present invention relates computer-implemented method for training a sit to stand movement of a user comprising the steps of:
receiving the sensed movement of the user,
analysing the sensed sit to stand movement,
determining one or more parameters related to the recorded sit to stand movement performed using a lifting apparatus of any one or more of the earlier statements,
storing the one or more parameters,
presenting the one or more parameters on a user device or on a display.

In one example the method further comprises the steps of: receiving a customized sit to stand exercise program, and; presenting the customised sit to stand exercise program on a display of the lifting apparatus or on a user device.

In one example the method comprises the steps of:
analysing the sensed sit to stand movement recorded by the one or more sensors,
determining the one or more parameters,
receiving the one or more parameters,
determining if a user has completed the customised exercise program,
storing the one or more parameters and number of times a user completes the customised exercise program.

In one example the method comprises the additional steps of:
receiving sensor readings from the one or more sensors as the user performs the sit to stand movement,
performing a sit to stand motion analysis based on the sensor readings,
determining a quality of each sit to stand repetition based comparing the recorded movement to a reference sit to stand movement.

In one example the method comprises: determining a customised sit to stand trajectory for a user, wherein the customised sit to stand trajectory is define in the customised exercise program, and; controlling the lifting apparatus to move the lifting unit in the customised sit to stand trajectory.

A data processing apparatus comprising means for carrying out the method for training a sit to stand movement defined in any of the statements above.

A computer program comprising instructions which, when the program is executed by a computer, cause the computer to carry out the method for training a sit to stand movement as defined in the earlier statements.

A computer-readable medium comprising instructions which, when executed by a computer, cause the computer to carry out the method for training sit to stand.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in Australia or any other country.

### BRIEF DESCRIPTION OF THE DRAWINGS

Embodiments of the present invention will now be described, by way of example, with reference to the accompanying drawings in which:

FIG. 1 illustrates an example embodiment of a lifting apparatus in accordance with the present invention.

FIG. 2 illustrates an example of the lifting apparatus with the lateral stabilising arms being in a stowed position.

FIG. 3 illustrates a detailed view of the lift mechanism, lifting unit and the movement of these parts.

FIG. 4 illustrates a detailed view of a lateral stabilising arm.

FIG. 5 illustrates a control schematic diagram illustrating the controller and its connections to other components.

FIG. 6 illustrates the lifting configuration and transport configuration, and the interchanging components to change between the two configurations.

FIG. 7 illustrates the lifting apparatus in a transport configuration with a user sitting on the seat.

FIG. 8 illustrates the lifting apparatus in a lifting configuration with a standing user.

FIG. 9 illustrates an example of an exercise system for training a user in a sit to stand movement.

FIG. 10 illustrates a schematic diagram of the hardware architecture of an exercise server of the exercise system.

FIG. 11 illustrates a software architecture of the exercise server of the exercise system.

FIG. 12 illustrates an example of up and go test performed by a user.

FIG. 13 illustrates a user interface presenting a simulated walking gait that is calculated in the training data analysis module by using a trained neural network.

FIG. 14 illustrates a user interface presenting trunk bending simulation and video as a user is performing a sit to stand movement.

### DETAILED DESCRIPTION OF THE PREFERRED EMBODIMENTS

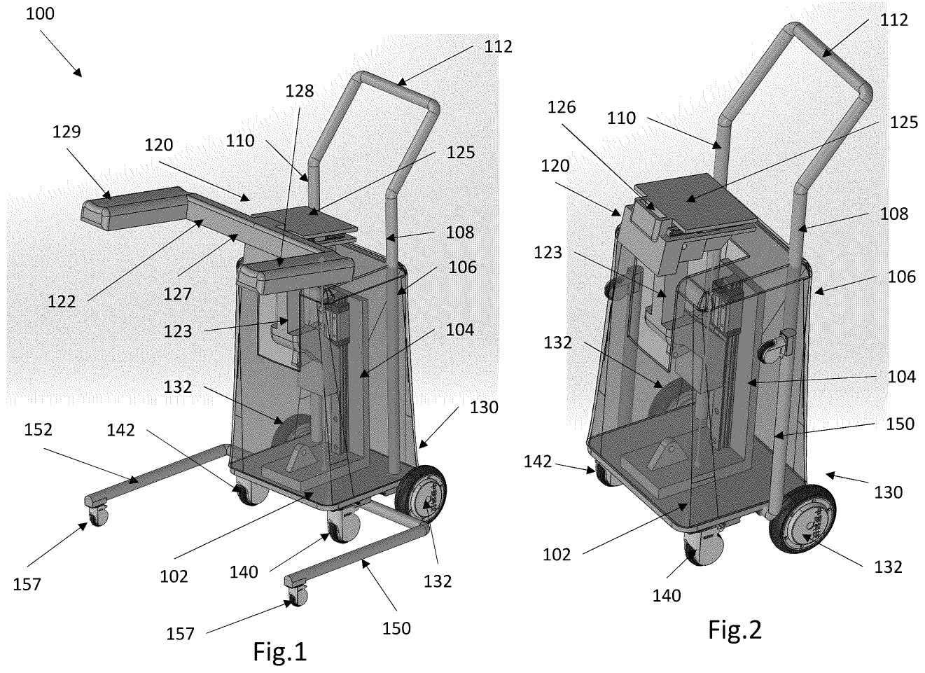

Referring to FIG. 1, an embodiment of the present invention is illustrated. This embodiment is arranged to provide a lifting apparatus for assisting a user to stand comprising: a chassis, a support structure extending upward from the chassis, a lift mechanism disposed on the support structure, a lifting unit adapted to couple to the lift mechanism and bear the weight of a user, wherein the lifting unit is moveable in three axes and moveable from a first position to a second position, and; wherein the lift mechanism is configured to move the lifting unit, and the lifting unit is configured to assist a user to a standing position from a seated position as the lifting unit is moved from a first position to a second position.

The lifting apparatus may be used as an exercise tool as part of an exercise system. The lifting apparatus may be used to assist a user stand from a seated position in daily use. The lifting apparatus may also be used to exercise and train a sit to stand movement of a user. The user may be able to use the lifting apparatus to perform sit to stand movements based on a custom exercise program defining a custom trajectory for the sit to stand movement and the number of repetitions and sets (i.e., reps and sets).

The lifting apparatus is particularly suited for elderly users. Elderly people often suffer from weaker lower body strength and can struggle to perform a sit to stand. Further elderly users can suffer from balance. There is a need to support elderly users while reducing the need for human helpers.

The lifting apparatus provides guidance and support to ensure individuals maintain correct posture. The lifting apparatus advantageously reduces the risk of strain or incorrect movement patterns as a user moves from a seated position to a standing position. The lifting apparatus is also advantageous as it is used as an exercise tool to strengthen a user's lower body muscle strength, trunk stability and core strength. The use of the lifting apparatus also helps to improve and build standing balance.

As shown in FIG. 1, the lifting apparatus 100 comprises a chassis 102. The chassis 102 may be a base. The lifting apparatus 100 further comprises a support structure 104. The support structure 104 is connected to the chassis 102 and extends upward from the chassis 102. A lift mechanism 120 is disposed on the support structure 104. The support structure 104 may be an upwardly extending beam or upward extending slab. A lifting unit 122 adapted to couple to the lift mechanism 120 and bear weight of the user. The lifting unit 122 is moveable in three axes and moveable from a first position to a second position.

The lifting apparatus 100 further comprises a casing 106 that is adapted to cover the support structure 104 and a portion of the chassis 102. The casing 106 may be removable. The lifting unit 122 is exposed and accessible. The lift mechanism 120 is configured to move the lifting unit 122. The lifting unit 122 is configured to assist a user to a standing position from a seated position as the lifting unit is moved from a first position to a second position.

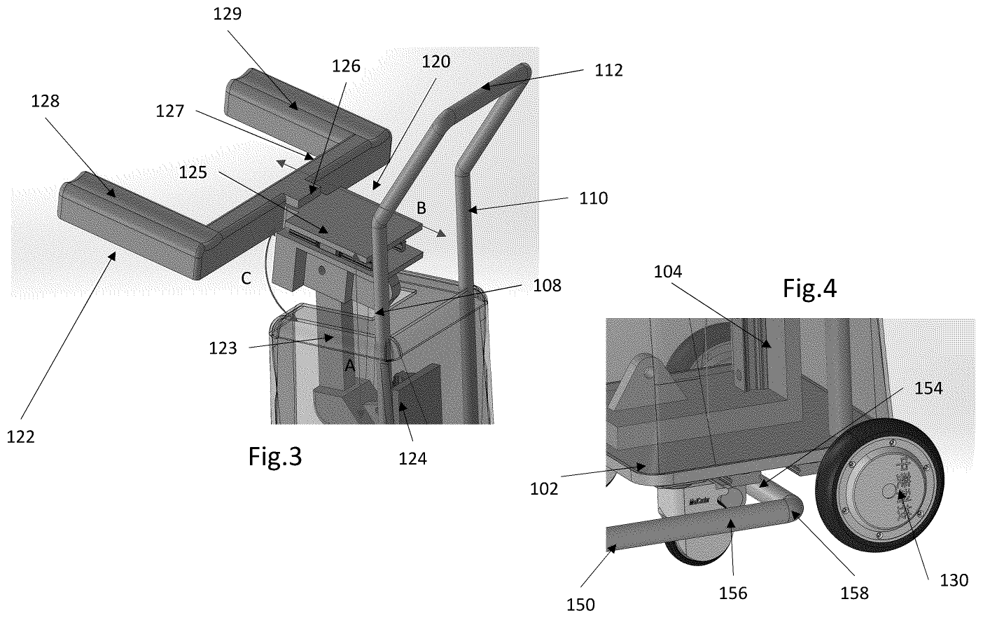

Referring to FIG. 1 and FIG. 3, the lifting unit 122 may comprise a central body and one or more outwardly extending arms. The outwardly extending arms may be load bearing arms adapted to bear the load of a user and provide a force on the user to assist the user to go from a sitting position to a standing position. As shown in FIG. 3, the lifting unit 122 comprises a central body 127 and two outwardly extending arms 128, 129 adapted to engage with a user. The extending arms 128, 129 may be load bearing arms. The arms 128, 129 are parallel to each other. The arms are shaped and structured to support a user 10 and assist a user 10 to stand from a sitting position.

The lifting apparatus 100 further comprises a pair of vertical stanchions 108, 110. The stanchions 108, 110 are coupled to the chassis 102 and extend upwardly from the chassis 102. The apparatus comprises a handle 112 coupled to each stanchion 108, 110 and extends upward. The handle 112 extends upward out of the casing 106 and is exposed.

The lifting apparatus 100 comprises a drive assembly 130 adapted to propel the lifting apparatus 100. The drive assembly 130 comprising at least two wheels 132, 134 attached to opposing sides of the chassis 102. The two wheels 132, 134 are drive wheels. The drive assembly comprises a hub motor operatively coupled to wheels and adapted to drive the wheels. In one example, the drive assembly 130 may comprise two hub motors 136, 138, where each hub motor is engaged to a drive wheel and configured to rotate the drive wheel 132, 134.

The drive assembly 130 further comprising one or more steering wheel adapted to assist with steering. In the illustrated example, the drive assembly 130 comprises two steering wheels 140, 142 disposed on the chassis. The steering wheels 140, 142 may be castor wheels. In one example the steering wheels 140, 142 may be identical to each other, or may be different sizes.

The lifting apparatus 100 may comprise at least two lateral stabilising arms and one or more rear support legs. In the illustrated embodiment, the lifting apparatus 100 comprises two stabilising arms 150, 152. Each stabilising arm 150, 152 is coupled to the chassis 120. Each stabilising arm extends laterally from the chassis. As shown in FIG. 4, each lateral stabilising arm 150, 152 comprises a lateral section 154 and an elongate section 156 connected by an elbow 158. The stabilising arms 150, 152 provide a wider base and are advantageous as they provide stability in the lateral direction to avoid tipping of the lifting apparatus 100. Each lateral stabilising arm 150, 152 is retractable and adapted to move between a retracted position and an operative position. FIG. 1 and FIG. 4 illustrates the stabilising arms being in the operative position.

FIG. 2 illustrates the arms in a retracted or stowed position. The retractable stabilising arms are advantageous as they can be retracted for a small footprint that makes storage easier and can also make transfer of the apparatus 100 simpler.

The lateral stabilising arms 150, 152 may be pivotable relative to the chassis. The arms 150, 152 may be configured to pivot about a vertical axis. The arms may be adapted to pivot outwardly in an arc. The stabilising arms 150, 152 may freely pivot as the apparatus 100 is moved to provide lateral stability and prevent the apparatus 100 from tipping. Each stabilising arm 150, 152 comprises a steering wheel 157. The steering wheel 157 may be attached at a free end of the arm 150, 152. The steering wheel 157 may be a freely rotatable wheel. In one example, the steering wheel may be castor wheel.

The lifting apparatus 100 may comprise one or more rear support legs. In the illustrated example, the lifting apparatus 100 comprises a rear support leg (i.e., a back support leg) 160. The rear support leg 160 is coupled to the chassis 102 and extends rearwardly. The rear support leg 160 is advantageous because it provides stability and prevents the apparatus 100 from tipping rearwardly. The rear support leg 160 may comprise a wheel 162. The wheel 162 may be a castor wheel or other freely rotatable wheel.

The lift mechanism 120 may comprise multiple components that are adapted to move the lifting unit 122 in a custom trajectory. In the illustrated example, the lift mechanism 120 comprises a column 123 that extends upwardly from the chassis 102. A trolley 124 is moveably mounted to the support structure 104. The column 123 is coupled to the trolley 124. The trolley 124 and column 123 are moveable vertically relative to the support structure. The support structure may comprise a track (not shown), and the trolley 124 is adapted to be mounted on and vertically move within the track.

The lift mechanism 120 comprises a coupling 126. The coupling 126 is disposed on the platform 125. The coupling 126 is adapted to connect to an opposing coupling disposed on the lifting unit 122. The coupling 126 allows removable connection between the lifting unit 122 and the platform 125 (and therefore a removable connection with the lift mechanism 120).

The lift mechanism 120 is configured to move independently in three axes. The lift mechanism 120 comprises a moveable platform 125 that is coupled to the column 123. The moveable platform 125 or a portion thereof is horizontally moveable. FIG. 3 illustrates the three motions by the three arrows A, B and C. Arrow A indicates vertical movement along a z axis (i.e., a vertical axis). Arrow B indicates movement along an x axis (horizontal axis). Arrow C indicates a pivoting motion about a y axis (i.e., a horizontal axis perpendicular to the x axis).

The lift mechanism 120 comprises three actuators 172, 174, 176. Each actuator is configured to move the lift mechanism in one axis. The lift mechanism 120 is adapted to move the lifting unit 122 in three axes and move the lifting unit 122 from the first position to the second position.

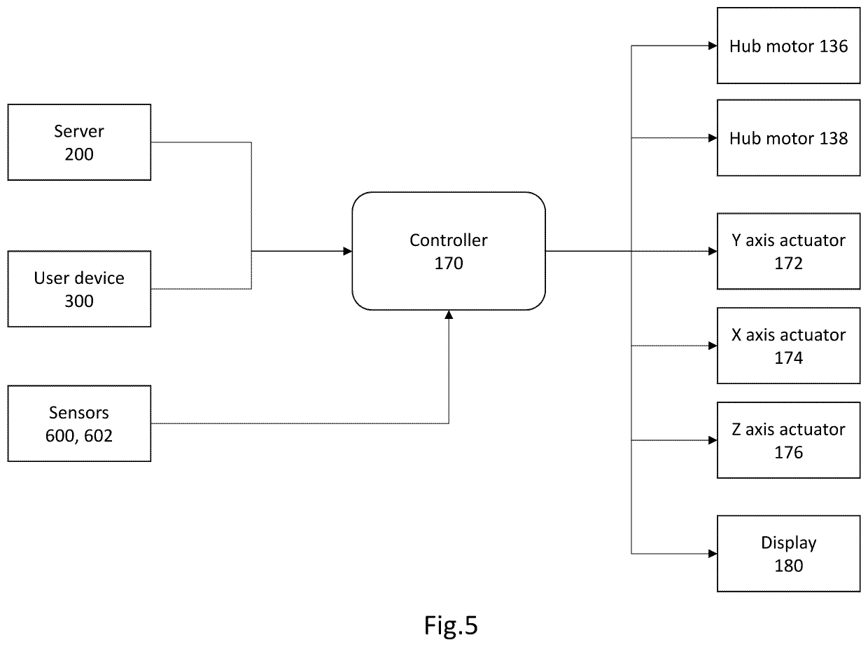

FIG. 5 illustrates a control schematic diagram illustrating the controller 170 and its connections to other components. The lifting apparatus 100 comprises a controller 170 operatively coupled to each actuator 172-176. The controller 170 is configured to control each actuator independently to move the lifting unit 122 from the first position to the second position.

In one example each actuator may be a linear actuator. Each linear actuator may comprise a DC motor and an encoder adapted to determine a position of the motor and provide the position information to the controller 170. The controller can utilise the encoder information to independently control each actuator 172-176. The lift mechanism is configured to move the lifting unit 122 along a customised trajectory. The controller 170 is adapted to receive data from one or more sensors 600, 602 and analyse the data to determine reps or quality of the sit to stand movement performed by the user.

The controller 170 may comprise a processor and a memory unit. Optionally, the controller 170 may also comprise a wireless communication module (not shown). The lifting apparatus 100 is adapted to wirelessly communicate with an exercise server 200 or a user device 300 or another device. The lifting apparatus 100 may optionally include a display 180. The display 180 may be a screen e.g., a LED or LCD screen.

The controller 170 is configured to receive or store a predefined lifting trajectory to move a user 10 along a customised path from a seated position to a standing position. The controller 170 may receive the customised path i.e., a customised lifting trajectory from an exercise server or a user device. The controller 170 is further configured to control the lift mechanism 120 to move the lifting unit 122 along the predefined lifting trajectory (i.e., the customised lifting trajectory).

In one example the predefined lifting trajectory may be a custom lifting trajectory for a specific user. The custom lifting trajectory may be changed or updated at regular intervals. The custom lifting trajectory may be defined as part of a custom exercise program for a user. In one example the controller is configured to control each of the three actuators independently to move the lift mechanism 120 and thereby move the lifting unit along the predefined lifting trajectory.

The lifting apparatus 100 is advantageous because it allows a custom lifting trajectory to be assessed. Most elderly users cannot lean forward due to poor trunk muscle control and muscle weakness in the core and trunk. These users often need to use their upper limbs to assist with the sit to stand movement. The lifting apparatus 100 facilitates an elderly user to use their upper limbs for the trunk forward leaning movement during the sit to stand movement. The lifting unit 122 can bear the load of a user via their arms resting on the lifting unit 122. The lifting unit 122 supports the user's arms and allows a user to lean forward while engaging their core and trunk muscles in a safe manner. This is advantageous as it reduces chances of injury to the user but still allows a user to perform the correct motion safely and thereby exercise the trunk and core musculature to improve their sit to stand motion.

The lifting apparatus 100 may be a modular arrangement that is changeable between a transport configuration and a lifting configuration (or exercise configuration). The lifting apparatus 100 may include one or more removable components. In the transport configuration the lifting apparatus is configured to transport a user. In the lifting configuration the lifting apparatus is configured to lift a user from a sitting position to a standing position.

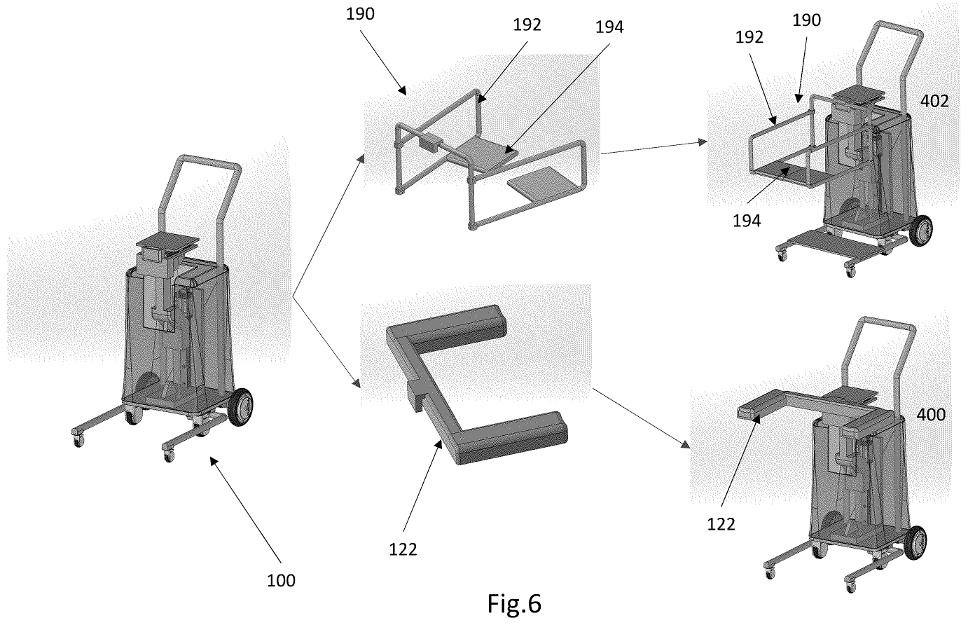

FIG. 6 illustrates the lifting configuration 400 and transport configuration 402, and the interchanging components to change between the two configurations. Referring to FIG. 6, the lifting apparatus may comprise a transport unit 190. The transport unit 190 may be adapted to be removably attached to the lift mechanism 120. The transport unit 190 comprises a cradle 192 and a seat disposed within the cradle 192. The seat 194 is adapted to support a user in a seated position. The transport unit 190 further comprises a foot stand 196. The foot stand 196 may extend between the lateral stabilising arms 150, 152.

As shown in FIG. 6, the lifting unit 122 and the transport unit 190 are removably attachable to the lift mechanism 120. The lifting unit 122 can be attached to the lift mechanism 120 to create the lifting configuration 400. The transport unit 190 can be attached to the lift mechanism 120 to create the transport configuration 402.

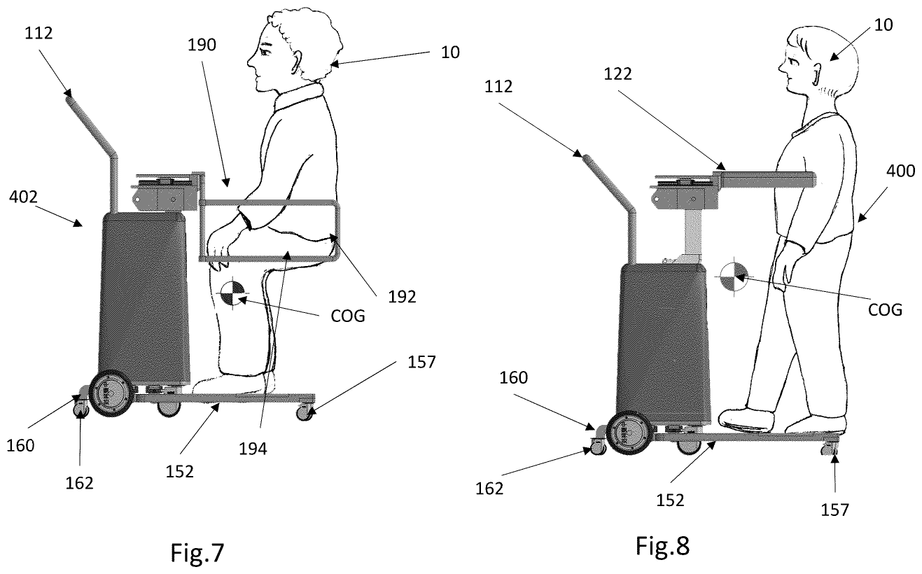

FIG. 7 illustrates a user operating the lifting apparatus 100 in a transport configuration 402. FIG. 8 illustrates a user operating the lifting apparatus 100 in a lifting configuration 400. Referring to FIG. 7, in a transport configuration 402 the user sits on the seat 194 in the cradle. The lifting apparatus 100 may be driven or propelled by the user. The user 10 can control the lifting apparatus 100 via the display 180. Alternatively, in a transport configuration 402 the lifting apparatus 100 may be manually pushed around. The seat 194 and the cradle 192 are shaped such that the centre of gravity COG of the user is substantially in the middle of the lifting apparatus 100. This avoids the lifting apparatus tipping over when the user is being transported. The shape of the cradle 192, the lateral stabilising arms 150, 152 and the rear support leg 160 provide a stable base for the lifting apparatus when being transported.

Referring to FIG. 8, in the lifting configuration 400, the lifting apparatus assists a user to move from a seated to standing i.e., the apparatus 100 assists a user to perform a sit to stand motion. As shown in FIG. 8, when the user is in a standing position a user can lean on the lifting unit 122, and the centre of gravity (COG) is substantially at the hips of the user. This is advantageous as it does not unevenly load a user's lower body.

The lifting apparatus provides several advantages. The lifting apparatus provides guidance and support to ensure individuals maintain correct posture. The lifting apparatus advantageously reduces the risk of strain or incorrect movement patterns as a user moves from a seated position to a standing position. The lifting apparatus further offers stability and balance assistance to a user. The lifting apparatus provides a simple tool to assist a user with sit to stand exercises. The lifting apparatus is also advantageous as it reduces the risk of falls or injuries during movement e.g., during standing. The lifting apparatus is also advantageous as it increases the confidence of a user (e.g., an elderly user) who may be concerned about their ability to perform sit to stand movement independently. The lifting apparatus 100 assists a user to perform a sit to stand which improves a user's confidence as a user is less likely to fall while using the apparatus. The support and assistance from the lifting apparatus 100 can improve a user's confidence and encourage a user to push themselves.

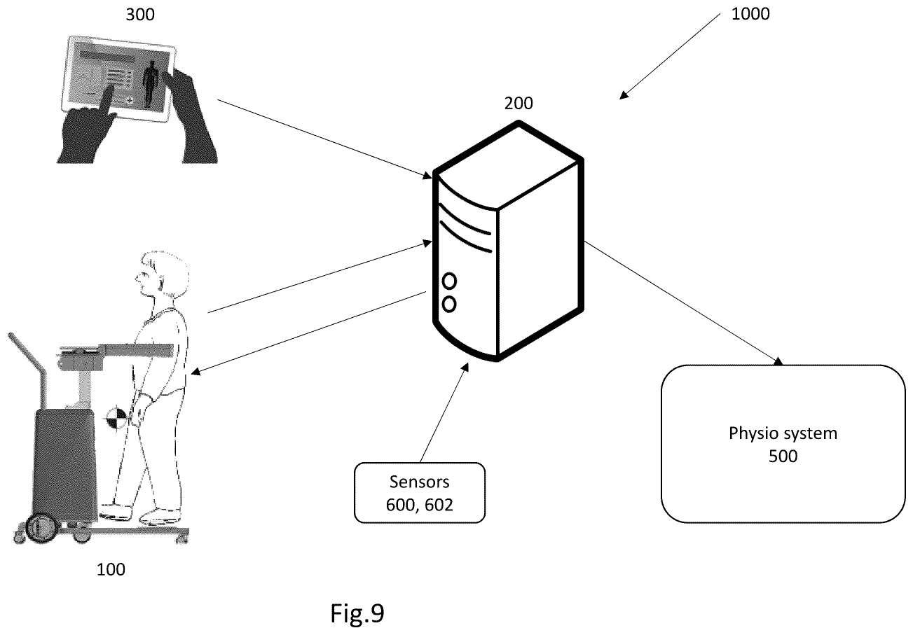

FIG. 9 illustrates an example embodiment of an exercise system 1000 for training a user. The exercise system 1000 may be particularly suited for elderly people who require assistance in a sit to stand. The system 1000 comprises the lifting apparatus 100 as described earlier. The system 1000 may optionally include a user device 300, that may provide a user interface. The system 1000 may further comprise an exercise server 200 that is configured for two-way communication with the lifting apparatus 100. Optionally, the system 1000 may include a physio system 500. The system 1000 may further comprise one or more sensors 600, 602 that are adapted to communicate with the exercise server 200.

The physio system 500 may be a system for an appropriate computing device or system associated with a physiotherapist or medical practitioner or other party that may prescribe an exercise program to a user.

The one or more sensors 600, 602 may be body worn sensors. The sensors 600, 602 may comprise a camera to record the sit to stand movement using the lifting apparatus 100. For example, the worn sensors may be an accelerometer or a gyroscope or a IMU including an accelerometer and a gyroscope.

In this example embodiment, the exercise server 200 may be implemented by a computer or computing device. The computer may be implemented by any computing architecture, including portable computers, tablet computers, stand-alone Personal Computers (PCs), smart devices, Internet of Things (IoT) devices, edge computing devices, client/server architecture, “dumb” terminal/mainframe architecture, cloud-computing based architecture, or any other appropriate architecture. The server 200 may be appropriately programmed to receive the sensed movement of the user, analyse the sensed sit to stand movement, determine one or more parameters related to the recorded sit to stand movement, store the one or more parameters, and present the one or more parameters on a user device e.g. user device 300 or on a display 180.

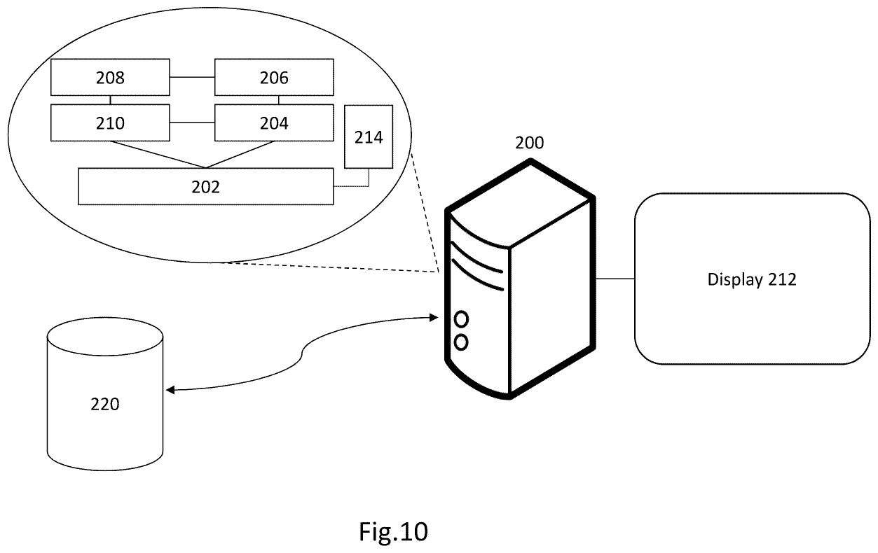

FIG. 10 illustrates a hardware schematic diagram of the exercise server 200. In this example embodiment the exercise server 200 includes suitable components necessary to receive, store and execute appropriate computer instructions. The components may include a processing unit 202, including Central Processing Unit (CPU), Math Co-Processing Unit (Math Processor), Graphic Processing Unit (GPUs) or Tensor processing unit (TPUs) for tensor or multi-dimensional array calculations or manipulation operations, read-only memory (ROM) 204, random access memory (RAM) 206, and input/output devices such as disk drives 208, input devices 210 such as an Ethernet port, a USB port, etc.

Optionally, the server 200 may include a display 212 such as a liquid crystal display, a light emitting display or any other suitable display and communications links 214. The server 200 may include instructions that may be included in ROM 204, RAM 206 or disk drives 208 and may be executed by the processing unit 202. There may be provided a plurality of communication links 214 which may variously connect to one or more other devices e.g., a lifting apparatus 100 or a user device 300 or a physio system 500 etc. The communication link may be a wireless communication module that allows the server 200 to perform wireless communication. At least one of a plurality of communications link may be connected to an external computing network through a telephone line or other type of communications link.

The server 200 may also comprise a training record database 220. The training record database may store a record of the sit to stand exercises performed by the user. The database 220 may store the exercise records including parameters for each exercise session, e.g., the reps and sets performed by the user. Records of multiple users may be stored in the database 220.

The exercise server 200 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The neural network may be trained to perform an object recognition process on received images or received video stream. The neural network may be trained to analyse signals from the sensors to perform sit to stand motion analysis. Optionally, the exercise server 200 may include multiple neural networks or other machine learning models. One network or model may be trained to perform an object recognition process to analyse the sit to stand motion. One network or model may be trained to perform sit to stand motion analysis on the sensor readings from the sensors 600, 602, e.g., the wearable sensors 600.

The exercise server 200 may be configured to receive the sensed movement of the user, determine one or more parameters related to the recorded sit to stand movement, and present the one or more parameters on a user device. The one or more parameters may be presented on the lifting apparatus display or on the exercise server display in addition or a user device 300 or as an alternative to being presented on the user device.

The one or more parameters may comprise any one of: number of sit to stand repetitions, number of sets, duration to complete the customised program. The one or more parameters may define a score. The score may be a quality score or a quantity score. A quality score may denote how well a user has performed a sit to stand movement. The quality score may also relate to how well a user has followed the custom sit to stand trajectory. The quantity score may relate to the number or reps and sets.

In one example, the exercise server may be configured to receive a customised sit to stand exercise program. The customized sit to stand program may be customised for a specific user.

In one example, the customised exercise program may be received from the physio system 500.

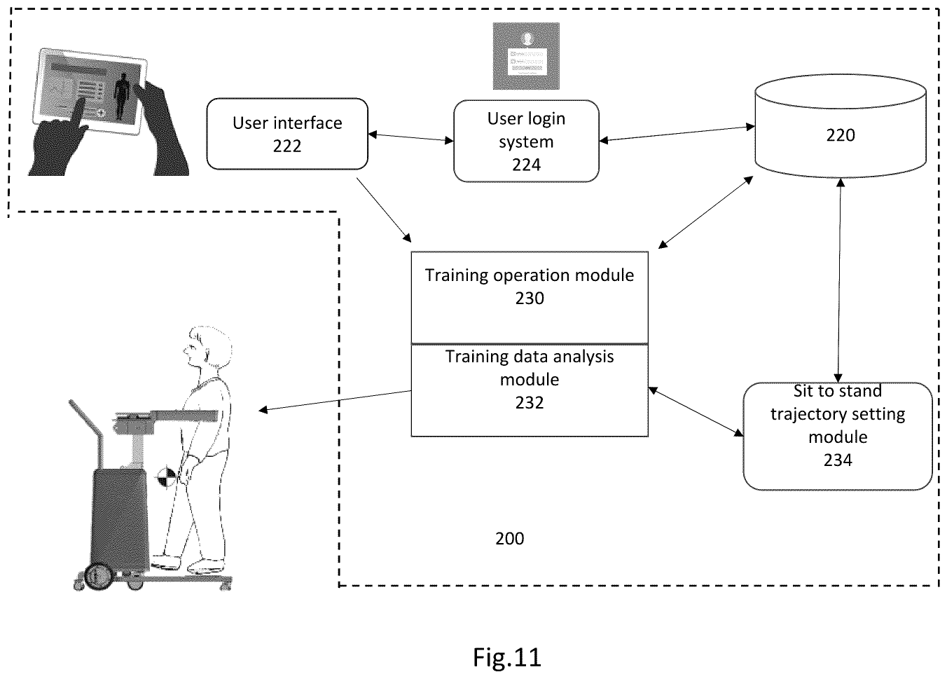

FIG. 11 illustrates an example architecture of the exercise server 200. FIG. 11 may be an example software architecture illustrating example software modules or software elements. The software modules may be executed by the hardware elements e.g., the processor 202. The exercise server 200 may comprise a user interface 222. The user interface 222 may allow communication of information to and from the user. The user interface 222 may be presented on the display 212 or may be presented on the user device 300. A user system login system 224 is adapted to allow a user to login. The user login system 224 may present a login page e.g., a webpage to a user to allow a user to enter unique login details. A user can select a specific exercise program associated with the user.

Referring to FIG. 11, the training operation module 230 is configured to receive the selected exercise program. The selected exercise program may be presented on the user interface 222. The exercise program may be stored in the training operation module 230 or may be accessed from the database 220. The training operation module 230 is configured to receive one or more parameters computed in the training data analysis module 232. The training operation module 230 is further configured to determine if a user has completed the customised exercise program. The completion information is stored in the database 220 and optionally, may be reported via the user interface 222.

In an alternative form, the training operation module 230, the training data analysis module 232 and the sit to stand trajectory setting module 234 may be hardware modules e.g., ASICs or integrated circuits constructed to perform the functions described herein. The modules 230-234 may include a combination of hardware and software elements and may be designed to perform the various functions defined herein.

The training data analysis module 232 is configured to analyse the sensed sit to stand movement recorded by the sensors. The training data analysis module 232 is configured to perform motion analysis of the sit to stand movements detected by the sensors 600, 602.

The training data analysis module 232 may be configured to receive sensor readings from the one or more sensors as the user performs the sit to stand movement. The data analysis module 232 may apply a machine learning model or a neural network to the sensor readings to assess a sit to stand motion analysis. The data analysis module 232 is configured to determine a quality of each sit to stand repetition based comparing the recorded movement to a reference sit to stand movement. The data analysis module 232 may be further configured to calculate the reps and sets of sit to stand movements performed by a user 10.

In one example, the server 200 may be configured to receive a video of the user performing the sit to stand movements defined in the exercise program. The exercise server may be configured to perform an object recognition process on the video stream to identify the user and assess the quality and number of reps of the sit to stand movement based on the object recognition process. In one example, the training data analysis may be configured to perform the object recognition process on the video stream.

The sit to stand trajectory setting module 234 is configured to calculate a customised sit to stand trajectory based on the exercise program. The specific trajectory may be defined in the customised exercise program. The customised sit to stand trajectory may be transmitted to the user interface and/or the controller 170 of the lifting apparatus. The controller 170, in a lifting configuration, may be configured to control the actuators 172-176 to move the lifting unit 122 in the custom trajectory.

In elderly persons, hospitalisation is associated with a decline in functional performance and loss of strength and/or muscle mass. This loss of strength and functional performance can make it difficult for elderly people to perform a sit to stand. In some instances, this lack of strength can cause a fall. Sit to stand training is an important strength training, especially for elderly people to maintain lower limb muscle strength, trunk stability and improve balance.

The customised exercise program may be executed using the lifting apparatus 100. One example customised training program may comprise:
6-week training (at least one session per week)
30 minutes per session
Week 1-2 (3 repetitions×2 sets)
Week 3-4 (3 repetitions×2 sets)
Week 5-6 (4 repetitions×2 sets)

The above exercise program is particularly useful for users above 60 years of age. The exercise server may be configured to simultaneously track at least 20 users and their performance of a specified sit to stand exercise program.

Sit to stand movements are a fundamental daily movement. The exercise system 1000, including the lifting apparatus 100 is advantageous because it allows a user to perform assisted sit to stand exercises with support. The system also tracks a user's performance of sit to stand movements and compliance to an exercise program. The exercise system 1000 is also advantageous because it allows delivery of a customised sit to stand exercise program with customised sit to stand trajectory.

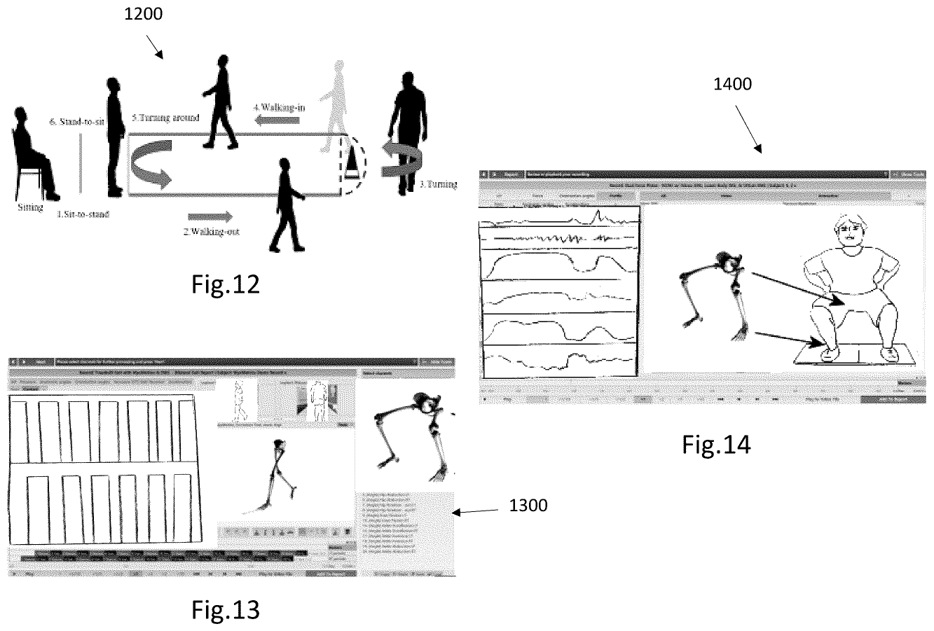

The exercise server 200 may prompt a user to perform one or more assessments. The server 200 may be configured to prompt a user to perform one or more of: 1) an up and go test, 2) standing balance test, 3) sit to stand test. The up and go test is used to assess the functional mobility of the user. Subjects (i.e., users) are required to stand up from a chair, walk forward 3 m, turn 180 degrees and walk back to the chair. FIG. 12 illustrates an example of up and go test 1200 performed by a user. The training data analysis module 232 may be configured to calculate the performance of the up and go test. Performance is determined based on the time taken. A 5% improvement in completion time is expected.

The standing balance test comprises a single leg stance test. This is used to assess the balance of a user. This is an extreme asymmetrical loading, and therefore assesses the weight bearing capacity of the user. This test is a known test that is used to assess balance of elderly persons. The single leg stance test includes a person standing on a single leg for time period. The user's ability to maintain stability may be rated on a 5-point scale (0-4). The module 232 may be used to assess the performance of the user based on sensor measurements. A 1 point improvement is expected in the single leg stance test.

The exercise system 1000 may be used to perform a sit to stand test. The test assesses the functional strength of the lower limbs (or lower body strength) of an elderly user. The participant is instructed via the display 180 or user interface 222 to stand up from sitting five times, without support. The total duration is recorded in seconds. The A 5 percent improvement is expected.

A user's health and strength can be assessed by requiring a user to perform the tests mentioned above. The assessment may be performed at regular time intervals e.g., at the conclusion of an exercise program.

The training data analysis module 232 may be further configured to perform a walking gait analysis. The analysis module 232 may include a neural network that is trained to process recorded video of a user walking to detect a walking gait. FIG. 13 illustrates a user interface 1300 presenting a simulated walking gait that is calculated in the training data analysis module 232 by using a trained neural network. The data presented may be used by an authorised person e.g., a physiotherapist (physio) to perform assessments of the user.

The training data analysis module 232 may be configured to perform a sit to stand analysis by using wearable motion sensors. For example, as shown in FIG. 14, a sit to stand analysis simulation 1400 is presented on the user interface 222 or display 180. In addition to a simulation a recording of the user may be presented. The analysis may be related to trunk forward bending. The forward trunk bending and angle of bend can relate to the quality of a sit to stand. The trunk bend angle may be one example parameter that relates to the quality of the sit to stand movement. The information from the training data analysis module 232 may be transmitted to an expert e.g., a physio system 500 to allow the expert to assess the performance of the user.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

In its various aspects, embodiments of the invention can be embodied in a computer-implemented process, a machine (such as an electronic device, or a general-purpose computer or other device that provides a platform on which computer programs can be executed), processes performed by these machines, or an article of manufacture.

1. A lifting apparatus for assisting a user to stand comprising:
a chassis,
a support structure extending upward from the chassis,
a lift mechanism disposed on the support structure,
a lifting unit adapted to couple to the lift mechanism and bear the weight of a user,
wherein the lifting unit is moveable in three axes and moveable from a first position to a second position, and;
wherein the lift mechanism is configured to move the lifting unit, and the lifting unit is configured to assist a user to a standing position from a seated position as the lifting unit is moved from a first position to a second position.

2. A lifting apparatus for assisting a user to stand of claim 1, wherein the lift mechanism comprises: three actuators, wherein each actuator is configured to move the lift mechanism in one axis, and;
wherein the lift mechanism is adapted to move the lifting unit in three axes and move the lifting unit from the first position to the second position.

3. A lifting apparatus for assisting a user to stand of claim 1, further comprising a controller operatively coupled to each actuator and configured to control each actuator independently to move the lifting unit from the first position to the second position.

4. A lifting apparatus for assisting a user to stand of claim 4, wherein the controller is configured:
to receive or store a predefined lifting trajectory to move a user along a customised path from a seated position to a standing position, and;
control the lift mechanism to move the lifting unit along the predefined lifting trajectory.

5. A lifting apparatus for assisting a user to stand of claim 5, wherein the predefined lifting trajectory is a custom lifting trajectory for a specific user.

6. A lifting apparatus for assisting a user to stand of claim 6, wherein the controller is configured to control each of the three actuators independently to move the lift mechanism and thereby move the lifting unit along the predefined lifting trajectory.

7. A lifting apparatus for assisting a user to stand of claim 7, wherein the lift mechanism comprising:
a column extending upwardly,
a trolley moveably mounted to the support structure and the column coupled to the trolley,
the column and trolley being moveable vertically relative to the support structure,
a moveable platform coupled to the column, the platform pivotable about vertical axis of the column and the platform or a portion of the platform being horizontally moveable,
wherein at least one actuator operatively connected to the trolley and adapted to actuate vertical movement of the trolley,
wherein at least one actuator operatively connected to the platform and adapted to facilitate pivoting of the platform, and;
wherein at least one actuator operatively connected to the platform or a portion of the platform and adapted to facilitate horizontal movement of the platform,
wherein the lifting unit comprises a central body and one or more outwardly extending arms to engage with a user, the lifting unit is removably coupled to the lifting mechanism.

8. A lifting apparatus for assisting a user to stand of claim 7, wherein the lifting unit comprises a pair of arms extending from a central beam, the arms extending outwardly from the central beam and parallel to each other, and wherein the central beam is removably coupled to the platform.

9. A lifting apparatus for assisting a user to stand of claim 1, wherein the apparatus is a modular arrangement including one or more removable components, wherein the lifting apparatus is adapted to be arranged in a transport configuration or a lifting configuration, and wherein the apparatus is operable in the transport configuration to transport a user or the lifting configuration to lift a user from a sitting position to a standing position.

10. A lifting apparatus for assisting a user to stand of claim 9, comprising:
a transport unit adapted to be removably attached to the lift mechanism,
wherein in the transport configuration the transport unit is attached to the lift mechanism and in the lifting configuration the lifting unit is attached to the lift mechanism.

11. A lifting apparatus for assisting a user to stand of claim 10, wherein the transport unit comprises a cradle, wherein the cradle and a seat disposed within the cradle, wherein the seat is adapted to support the user when in a seated position.

12. A lifting apparatus for assisting a user to stand of claim 9, comprising:
at least two lateral stabilising arms,
each stabilising arm coupled to the chassis and extending laterally from the chassis, and;
each lateral stabilising arm is retractable and adapted to move between a retracted position and an operative position.

13. A lifting apparatus for assisting a user to stand of claim 12, comprising one or more rear support legs, each of the one or more rear support legs coupled to the chassis and extending rearwardly from the chassis.

14. A lifting apparatus for assisting a user to stand of claim 13, wherein the apparatus comprises a drive assembly adapted to propel the lifting apparatus,
wherein the drive assembly comprising at least two wheels attached to opposing sides of the chassis and a hub motor operatively coupled to wheels and adapted to drive the wheels, and;
the drive assembly further comprising one or more steering wheel adapted to assist with steering.

15. An exercise system for training a user comprising:
a lifting apparatus according to claim 1;
an exercise server adapted to communicate with the lifting apparatus,
one or more sensors configured to sense a sit to stand movement performed by a user using the lifting apparatus,
wherein the exercise server configured to:
receive the sensed movement of the user,
analyse the sensed sit to stand movement,
determine one or more parameters related to the recorded sit to stand movement,
store the one or more parameters,
present the one or more parameters on a user device.

16. An exercise system for training a user of claim 15, wherein the exercise server is configured to:
receive a customized sit to stand exercise program,
present the customised sit to stand exercise program on a display of the lifting apparatus or on a user device.

17. An exercise system for training a user of claim 16, wherein the one or more parameters comprise: number of sit to stand repetitions, number of sets, duration to complete the customised program.

18. An exercise system for training a user of claim 15, wherein the exercise server comprising:
a training data analysis module configured to:
analyse the sensed sit to stand movement recorded by the one or more sensors,
determine the one or more parameters,
a training operation module configured to:
receive the one or more parameters,
determine if a user has completed the customised exercise program,
a training record database configured to store the one or more parameters and number of times a user completes the customised exercise program.

19. An exercise system for training a user of claim 18, wherein the one or more sensors comprise at least a worn sensor and a camera to record the sit to stand movement using the lifting apparatus.

20. An exercise system of claim 19, wherein the exercise server is configured to:
receive sensor readings from the one or more sensors as the user performs the sit to stand movement,
performing a sit to stand motion analysis based on the sensor readings,
determine a quality of each sit to stand repetition based comparing the recorded movement to a reference sit to stand movement.
